(19) United States
(12) Patent Application Publication
(10) Pub. No.: US 2006/0210680 A1
(43) Pub. Date: Sep. 21, 2006

(54) Process for reducing oil and fat content in cooked potato

(76) Inventors: Stephen D. Kelleher, Ipswich, MA (US); Wayne S. Saunders, Gloucester, MA (US); Peter G. Williamson, Gloucester, MA (US)

Correspondence Address: Paul J. Cook, 115 Pine Street, Manchester, MA, 01944, US

(21) Appl. No.: 11/437,760

(22) Filed: May 22, 2006

Related U.S. Application Data
(63) Continuation-in-part of application No. 10/991,637, filed on Nov. 18, 2004.
(60) Provisional application No. 60/529,929, filed on Dec. 16, 2003.

(51) Int. Cl. A23L 1/31

(52) U.S. Cl. 426/281; 426/637

(57) ABSTRACT

A process for cooking a food in oil and/or fat is provided. An acidic dry protein mixture, an alkaline dry protein mixture, an aqueous alkaline protein mixture or an aqueous acidic protein is added to a food prior to cooking. The food containing the protein is cooked in a fat and/or oil. Accumulated fat and/or oil on the surfaces of the cooked food then is removed. The acidic dry protein mixture, alkaline dry protein mixture, aqueous alkaline protein mixture and aqueous acidic protein solution comprise myofibrillar proteins and sarcoplasmic proteins substantially free of myofibrils and sarcomeres. The amount of oil and/or fat absorbed by the food during cooking is substantially reduced.

### REFERENCE TO RELATED APPLICATION

This application is a continuation-in-part of application Ser. No. 10/991,637, filed Nov. 18, 2004 which claims the benefit of the filing date of provisional application Ser. No. 60/529,929, filed Dec. 16, 2003.

### BACKGROUND OF THE INVENTION

This invention relates to a process for controlling oil and fat content in cooked food. More particularly, this invention relates to such a process which utilizes animal muscle protein or a peptide composition derived from animal muscle protein and a step of physically recovering accumulated fat and/or oil on the food to control oil and fat content in food.

Prior to the present invention, foods such as meat, vegetables, fish, nuts, pastry, fritters, doughnuts, potatoes or the like cooked at an elevated temperature in oil and/or fat absorb the oil and/or fat. These cooking processes are commonly referred to as “deep fat frying” or as “sauteing”. When the food is only partially cooked in fat and/or oil, the cooked food is referred to as “par fried”. The fried food then is subsequently fully cooked such as by baking. When cooked in this manner, the cooked food undesirably absorbs the fat or oil thereby reducing its nutritional and dietary value. A prior solution for reducing fat or oil absorption by the food during cooking is to coat the food with a substance such as pectin prior to contacting the food with the heated oil or fat. This solution is undesirable since significant oil or fat absorption by the food still occurs.

Accordingly, it would be desirable to provide a form of food including fish, meat, vegetables, pastry, potatoes or the like which can be cooked while minimizing or preventing absorption of oil or fat by the food during cooking. In addition, it would be desirable to provide such a form of food which is not less nutritional than the original food or which is even more nutritional than the original food to be cooked. In addition, it would be desirable to provide such a form of food wherein the majority of moisture or added flavors or spices in the uncooked food is retained during cooking.

### SUMMARY OF THE INVENTION

In accordance with this invention, uncooked food to be cooked with liquid oil and/or fat, including butter is coated, injected and/or admixed with a dry protein mixture derived from animal muscle tissue, an aqueous acidic protein solution derived from animal muscle tissue, an aqueous alkaline protein solution derived from animal muscle tissue and/or a peptide composition derived from the dry protein mixture, from the aqueous acidic protein solution or from the aqueous alkaline protein solution. The food containing the protein then is cooked in fat and/or oil. Fat and/or oil accumulated on the surface of the cooked food then is physically removed from the cooked food. The protein mixtures comprise a mixture of myofibrillar proteins and sarcoplasmic proteins obtained by one of the processes disclosed in U.S. Pat. Nos. 6,005,073; 6,288,216; 6,136,959 and/or 6,451,975 all of which are incorporated herein by reference in their entirety. By the phrase, “dry protein mixture” as used herein is meant a dehydrated, protein mixture of myofibrillar proteins and sarcoplasmic proteins derived from animal muscle tissue and which is obtained from an aqueous acidic protein solution (less than or equal to pH 4.0) (acidic dry protein mixture) or an aqueous alkaline protein solution (greater than or equal to pH 10.5) (alkaline dry protein mixture). The dry protein mixture also contains less than about 15 weight percent water, preferably between about 3 and 10 weight percent water and most preferably between about 3 and 7 weight percent water based on the total weight of the protein mixture and water. While a dry protein mixture containing 0% water is useful in the present invention, dry powders, in general, containing 0 to 3 weight percent water can be dangerous to process on a commercial scale. Solid mixtures of myofibrillar proteins and sarcoplasmic proteins containing greater than about 15 weight percent water based on total weight of the protein mixture and water are undesirable in this invention since they are microbially unsound.

By the phrase “aqueous acidic protein solution” as used herein is meant an aqueous solution of myofibrillar proteins and sarcoplasmic proteins derived from animal muscle tissue and having a pH of 4.0 or less, preferably pH 3.5 or less and most preferably between about 2.5 and about 3.5 but not so low as to adversely affect the protein functionality. The aqueous acidic protein solution can be obtained directly from animal muscle tissue by the processes described below or by dissolving the dry protein mixture in water or in a pharmaceutically or food grade acceptable aqueous acidic solution.

By the phrase, “aqueous alkaline protein solution” as used herein is meant an aqueous solution of myofibrillar proteins and sarcoplasmic proteins having a pH from about 10.5 to about 12.0. The aqueous alkaline protein solution can be obtained directly from animal muscle tissue by the process described below. A dry alkaline protein mixture is obtained by drying the aqueous alkaline protein solution such as by lyophilization, evaporation or spray drying.

In accordance with this invention the acidic dry protein mixture of myofibrillar proteins and sarcoplasmic protein, in powder form, dehydrated form or small particulate form and/or peptide composition derived therefrom is applied to the surface of the food to be cooked, is injected into the food to be cooked and/or is mixed with the food (ground, minced or thinly sliced) to be cooked such as hamburger or sausage. Alternatively, the aqueous acidic protein solution and/or peptide composition derived from the aqueous acidic protein solution can be applied to the surface of the food or it can be mixed with the food and/or it can be injected into the food. The food containing the acidic dry protein mixture, or aqueous acidic protein solution and/or peptide composition derived therefrom then can be cooked in liquid oil and/or fat at elevated temperature while minimizing absorption of oil and/or fat by the food. Fat and/or oil accumulated on the surface of the cooked food then is physically removed from the surface of the cooked food. The difference in weight of fat and/or oil between food treated in accordance with this invention after being cooked in oil and/or fat compared with food without the dry protein mixture or aqueous acidic protein solution and/or peptide composition derived therefrom after being cooked in oil and/or fat is between about 10 and about 70%, more preferably, between about 30 and about 70% less oils and/or fat. In addition, since the amount of absorbed fat or oil utilized during cooking is substantially reduced, the amount of oil or fat needed to cook a given weight of food is correspondingly substantially reduced.

Alternatively, in accordance with this invention the dry alkaline protein mixture of myofibrillar proteins and sarcoplasmic protein, in powder form, dehydrated form or small particulate form and/or peptide composition derived from the dry alkaline protein mixture is applied to the surface of the food to be cooked, is injected into the food to be cooked and/or is mixed with the food (ground, minced or thinly sliced) to be cooked such as hamburger or sausage. Alternatively, the aqueous alkaline protein solution and/or peptide composition derived from the aqueous alkaline protein solution can be applied to the surface of the food and/or it can be mixed with the food and/or it can be injected into the food. The food containing the alkaline dry protein mixture or aqueous alkaline protein solution and/or peptide composition derived therefrom then can be cooked in liquid oil and/or fat at elevated temperature while minimizing absorption of oil and/or fat by the food. Fat and/or oil accumulated on the surface of the cooked food then is physically removed from the surface of the cooked food. The difference in weight of fat and/or oil between food treated in accordance with this invention after being cooked in oil and/or fat compared with food without the dry alkaline protein mixture or aqueous alkaline protein solution and/or peptide composition derived therefrom after being cooked in oil and/or fat is between about 10 and about 70%, preferably, between about 30 and about 70% less oil and/or fat. In addition, since the amount of absorbed fat or oil utilized during cooking is substantially reduced, the amount of oil or fat needed to cook a given weight of food is correspondingly substantially reduced.

The peptide composition useful in the present invention is obtained by contacting the dry protein mixture, the aqueous acidic protein solution or the aqueous alkaline protein solution with an enzyme composition which converts the protein to a peptide composition at the pH of the protein composition. The peptide composition can be an acidic dry peptide composition, an aqueous acidic peptide solution, an aqueous alkaline peptide solution or an alkaline dry peptide mixture.

### DESCRIPTION OF SPECIFIC EMBODIMENTS

In accordance with this invention, food to be cooked in oil and/or fat is coated, injected with and/or admixed with a acidic dry protein mixture, a alkaline dry protein mixture, an aqueous acidic protein solution or an aqueous alkaline protein solution of myofibrillar proteins and sarcoplasmic proteins derived from animal muscle tissue and/or a peptide composition derived from the acidic dry protein mixture, the alkaline dry protein mixture, the aqueous acidic protein solution or the aqueous alkaline protein solution. The acidic dry protein mixture, alkaline dry protein mixture, aqueous alkaline protein solution and aqueous acidic protein solution are obtained by the processes disclosed in U.S. Pat. Nos. 6,005,073, 6,288,216, 6,136,959 and 6,451,975 all of which are incorporated herein by reference in their entirety. The peptide composition utilized in the present invention is obtained by contacting the acidic dry protein mixture, the aqueous acidic protein solution, the alkaline dry protein mixture or the aqueous alkaline protein solution with an enzyme that converts the protein to a peptide.

The dry protein mixture is obtained by one of four processes. In two processes, (acid processes) animal muscle tissue is formed into small tissue particles which are then mixed with sufficient acid to form a solution of the tissue having a pH of 4.0 or less, preferably 3.5 or less and most preferably between about 2.5 and about 3.5, but not such a low pH as to adversely modify the animal tissue protein. In one of these two processes, the solution is centrifuged to form a lowest membrane lipid layer, an intermediate layer of aqueous acidic protein solution and a top layer of neutral lipids (fats and oils). The intermediate layer of aqueous acidic protein solution then is separated from the membrane lipid layer or from both the membrane lipid layer and the neutral lipid layer. In a second of these two processes, no centrifugation step is effected since the starting animal muscle tissue contains low concentrations of undesired membrane lipids, oils and/or fats. In both processes, the protein mixture is free of myofibrils and sarcomeres. In both processes, the protein in the aqueous acidic protein solution can be recovered after centrifugation (when used) or by drying the aqueous acidic solution, such as by evaporation, spray drying or lyophilization to form the dry protein mixture having the low pH it had when it was dissolved in the aqueous acidic protein solution. Alternatively, the aqueous acidic protein solution can be utilized with the uncooked food without drying the solution. It is preferred to utilize one of these two acid processes to obtain the dry protein mixture or the aqueous acidic protein solution. In another alternative process, the protein in the aqueous acidic protein solution can be precipitated and recovered and mixed with a pharmaceutically acceptable or food grade acid to form an aqueous acidic protein solution of a desired viscosity. In another alternative process, the proteins in the acidic protein solution can be raised to a pH between about 10.5 and 12 using base to form an aqueous alkaline protein solution.

In two other processes, (alkaline processes) which also provide a means for obtaining the dry alkaline protein mixture, animal muscle tissue is formed into small tissue particles which are then mixed with sufficient aqueous base solution to form a solution of the tissue wherein at least 75% of the animal muscle protein is solubilized, but not such a high pH as to adversely modify the animal tissue protein, i.e., a pH between about 10.5 and about 12. In one process, the solution is centrifuged to form a lowest membrane lipid layer, an intermediate aqueous protein rich layer and a top layer of neutral lipids (fats and oils). The intermediate aqueous alkaline protein-rich layer then is separated from the membrane lipid layer or from both the membrane lipid layer and the neutral lipid layer. In a second process, no centrifugation step is effected since the starting animal muscle proteins contain low concentrations of undesired membrane lipids, oils and/or fats. In both processes, the protein mixture is free of myofibrils and sarcomeres. In both of these processes, the aqueous alkaline protein solution can be recovered at this point. In both processes, the pH of the protein-rich aqueous phase can be lowered to a pH below about 4.0, preferably below about 3.5 and most preferably between about 2.0 and 3.5 to form the aqueous acidic protein solution. In both processes, the protein in the aqueous acidic protein solution is recovered after centrifugation (when used) by drying the aqueous acidic protein solution, such as by evaporation, spray drying or lyophilization to form a powder product having the low pH it had when it was dissolved in the aqueous acidic solution. Alternatively, the aqueous alkaline protein solution can be applied directly to the food without drying. The protein in aqueous alkaline solution having a pH between about 10.5 and 12.0 recovered after centrifugation (when used) can be dried, such as by spray drying, evaporation or lyophilization to form a powder product.

The acidic dry protein mixture, the alkaline dry protein mixture, the aqueous acidic protein solution, the aqueous alkaline protein solution and/or the peptide composition derived therefrom then is coated or injected into and/or admixed with the uncooked food. The acidic dry protein mixture, alkaline dry protein mixture, aqueous acidic protein solution, aqueous acidic protein solution and/or peptide composition derived therefrom can be applied alone or in admixture with conventional food or nutritive additives such as breading or batter coatings, spice dry rubs, cracker meal, corn meal or the like. The acidic dry protein mixture, the alkaline dry protein mixture, the aqueous alkaline protein solution, the aqueous acidic protein solution and/or peptide composition derived therefrom can be coated on the surface of the uncooked food with an applicator, sprayed on or can be coated by immersion tumbling the uncooked food in the solution or in a marinade containing the aqueous acidic protein solution, the alkaline dry protein mixture, the aqueous alkaline protein solution or the acidic dry protein mixture in a container or tumbling or vacuum tumbling apparatus. The applied protein composition also can contain flavorants such as butter flavor or garlic flavor or the like.

In one embodiment of this invention, the food containing the applied protein composition is frozen such as by contact with liquid nitrogen or in a conventional freezing apparatus or the like prior to cooking in oil and/or fat prior to cooking in oil and/or fat.

The food containing the protein then is cooked in hot fat and/or oil. The fat and/or oil accumulated on the surface of the cooked food then is physically removed from the surface of the cooked food. Representative suitable means for physically removing accumulated fat and/or oil on the surface of the cooked food include superatmospheric gas such as air from a gas blower; passing the cooked food through a zone of subatmosphere pressure (vacuum); subjecting the cooked food to a combination of superatmospheric gas on one surface and subatmospheric pressure on an opposite surface to promote migration of accumulated fat and/or oil toward the vacuum; passing the cooked food onto a vibrating conveyor having holes therethrough such as a mesh conveyer to remove fat and/or oil from the cooked food by gravity; contacting the cooked food with a food grade absorber material or the like. When a vibrating conveyor is utilized, the food can be subjected to a pressurized gas, with or without a vacuum as described above.

In summary, the acidic dry protein mixture, alkaline dry protein mixture, aqueous alkaline protein solution or the aqueous acidic protein solution utilized in the present invention can be obtained by the following representative methods:
1. Reduce the pH of comminuted animal muscle tissue to a pH less than about 3.5 to form an acidic protein solution, centrifuge the solution to form a lipid-rich phase and an aqueous phase and recover an aqueous acidic protein solution substantially free of membrane lipids that can be used in this invention.
2. Spray dry the aqueous acidic protein solution obtained by method 1 to form a dry protein mixture substantially free of membrane lipids that can be used in the present invention.
3. Lyophilize or evaporate the aqueous acidic protein solution obtained by method 1 to form the acidic dry protein mixture substantially free of membrane lipids that can be used in the present invention.
4. Increase the pH of the aqueous acidic protein solution from method 1 to about pH 5.0-5.5 to effect precipitation of the proteins and then readjust the protein back to a pH of about 4.5 or less using acid in a minimum volume to concentrate the aqueous acidic protein solution to between 1.6-15% protein.
5. Reduce the pH of comminuted animal muscle tissue to form an aqueous acidic protein solution that can be used in the present invention.
6. Spray dry the aqueous acidic protein solution obtained by method 5 to form the acidic dry protein mixture that can be used in the present invention.
7. Lyophilize or evaporate the aqueous acidic protein solution obtained by method 5 to form the acidic dry protein mixture that can be used in the present invention.
8. Increase the pH of the aqueous acidic protein solution from method 5 to about pH 5.0-5.5 to effect precipitation of the proteins and then readjust the protein back to a pH of about 4.0 or less using acid in a minimum volume to concentrate the aqueous acidic protein solution to between about 1.6-15% protein.
9. Increase the pH of comminuted animal muscle tissue to a pH above about 10.5, centrifuge the solution to form a lipid-rich phase and an aqueous phase and recover an aqueous alkaline protein solution. In one embodiment, reduce the pH of the aqueous alkaline solution to a pH of less than about 4.0 to obtain an aqueous acidic protein solution substantially free of membrane lipids that can be used in this invention. In a second embodiment, reduce the pH of the aqueous alkaline solution to about 5.0-5.5 to precipitate the protein, lower the pH of the precipitated protein to a pH of 4.0 or less to form a concentrated aqueous acidic protein solution and use the concentrated aqueous acidic solution or dry the solution and use the recovered dry protein.
10. Spray dry the aqueous acidic protein solution obtained by method 9 to form a dry protein mixture substantially free of membrane lipids that can be used in the present invention.
11. Lyophilize or evaporate the aqueous acidic protein solution obtained by method 9 to form the acidic dry protein mixture substantially free of membrane lipids that can be used in the present invention.
12. Increase the pH of the aqueous acidic protein solution from method 9 to about pH 5.0-5.5 to effect precipitation of the proteins and then readjust the protein back to a pH of about 4.0 or less using acid in a minimum volume to concentrate the aqueous acidic solution to between 1.6-15% protein.
13. Increase the pH of comminuted animal muscle tissue to a pH above about 10.5 to form the aqueous alkaline protein solution. In one embodiment, reduce the pH of the aqueous alkaline protein solution to below about 4.0 to form an aqueous acidic protein solution that can be used in the present invention. In a second embodiment, reduce the pH of the aqueous alkaline solution to about 5.0-5.5 to precipitate the protein, lower the pH of the precipitated protein to a pH of 4.0 or less to form a concentrated aqueous acidic solution and use the concentrated aqueous acidic protein solution or dry the solution and use the recovered dry protein mixture.
14. Spray dry the aqueous acidic protein solution obtained by method 13 to form an acidic dry protein mixture that can be used in the present invention.
15. Lyophilize or evaporate the aqueous acidic protein solution obtained by method 13 to form the acidic dry protein mixture that can be used in the present invention.

The protein products utilized in the present invention comprise primarily myofibrillar proteins that also contains significant amounts of sarcoplasmic proteins. The sarcoplasmic proteins in the protein composition admixed with, injected into and/or coated on the uncooked food comprises above about 8%, preferably above about 10%, more preferably above about 15% and most preferably above about 18%, up to about 30% by weight sarcoplasmic proteins, based on the total weight of protein in the acidic dry protein mixture, alkaline dry protein mixture, the aqueous alkaline protein solution or aqueous acidic protein solution.

The protein compositions utilized in the present invention are derived from animal muscle tissue such as meat, fish or poultry, including shellfish muscle tissue. Representative suitable fish include deboned flounder, sole haddock, cod, sea bass, salmon, tuna, trout or the like. Representative suitable shellfish include shelled shrimp, crayfish, lobster, scallops, clams, oysters or shrimp in the shell or like. Representative suitable meats include beef, lamb, pork, venison, veal, buffalo or the like; poultry such as chicken, mechanically deboned poultry meat, turkey, duck, a game bird or goose or the like.

In accordance with one embodiment of this invention, the acidic dry protein mixture, alkaline dry protein mixture, aqueous alkaline protein solution or aqueous acidic protein solution of myofibrillar proteins and sarcoplasmic protein is mixed with one or more enzymes, which convert the protein to peptides thereby to produce a peptide composition which is added to food prior to cooking the food in fat and/or oil in order to reduce fat and/or oil absorption by the cooked food. The enzymes can be exoproteases and can be active to produce peptides at an acidic pH, an alkaline pH or a neutral pH. Representative suitable enzymes useful at acidic pH include Enzeco Fungal Acid Protease (Enzyme Development Corp., New York, N.Y.; Newlase A (Amano, Troy, Va.); and Milezyme 3.5 (Miles Laboratories, Elkhart, Ind.) or mixtures thereof. Representative suitable enzymes useful at alkaline pH include Alcalase 2.4 LFG (Novozyes, Denmark). Representative suitable enzymes useful at neutral pH include Neutrase 0.8 L (Novozymes, Denmark) and papain (Penta, Livingston, N.J.) or mixtures thereof. After, the peptides have been formed, their pH can be adjusted, either alone or in admixture with the protein composition of this invention to pH below about 4.0 or between about 10.5 and about 12.0 prior to applying them to an uncooked food to be cooked.

The enzymes utilized in amounts of between about 0.02% and about 2% preferably between about 0.05% and about 0.5% by weight based on the total weight of enzyme and protein at temperatures between about 4° C. and about 55° C., preferably between about 25° C. and about 40° C., for a time between about 5 mins. and about 24 hrs., preferably between about 0.5 hrs. and about 2 hrs. The enzyme can be inactivated by changing pH of the protein composition with which it is mixed. The peptides formed by reaction of the protein composition with the enzyme composition then can be recovered by drying the solution wherein the reaction takes place. Drying can be effected by evaporation, spray drying, freeze-drying or the like. The peptides produced are instantaneously soluble in water at neutral pH. The peptide composition can be added to uncooked food for the purposes set forth above.

The peptide products useful in this invention contain less than about 1 weight percent fats and oils (total), preferably less than about 0.2% weight percent fats and oils based on the weight of peptide. In addition, the peptide products utilized in the present invention contain less than about 2 weight percent ash, preferably less than about 0.2% weight percent fats and oils based on the weight of peptide. This low ash content is achieved by washing with water the protein starting material. Ash is defined as minerals, such as sodium, potassium, calcium, iron or phosphorous. In addition, the peptide products of this invention are instantly soluble in water to form a clear solution. Furthermore, the peptide products of this invention generally have lighter color whiteness units than the color whiteness units of a similar unhydrolyzed protein isolate from which they are derived as measured by a colorimeter with L, a, b capabilities. This lighter color is found with the hydrolyzed peptides of this invention derived from meats such as beef, pork or chicken as well as from dark muscle tissue from fish such as pelagic fish. This lighter color characteristic is desirable since it more easily permits dissolving the peptide product in water to form clear aqueous solutions.

Color whiteness index is determined by converting the L, a, b values utilizing the formula: 100[(100-L)²+a²+b²] ^{0.5}. Color is measured using a tristimulus calorimeter utilizing the universally adopted “L, a, b” opponent-type scale developed by Richard Hunter as is well known in the art. “L” is a measure of light ranging from white to black. The “a” value measures the range from green to red, and the “b” value measures the range from blue to yellow. With these three coordinates, a three-dimensional value can be assigned to any color.

In accordance with this invention the aqueous acidic protein solution, aqueous alkaline protein solution, the alkaline dry protein mixture or the acidic dry protein mixture of myofibrillar proteins and sarcoplasmic proteins, and/or the peptide composition derived therefrom is applied to a surface of uncooked food to be cooked, or is injected into and/or is mixed with the uncooked food to be cooked. In a preferred embodiment of this invention, the uncooked food is both injected with and coated with the protein and/or peptide composition set forth above. The acidic dry protein mixture, alkaline dry protein mixture, aqueous alkaline protein solution or aqueous acidic protein solution can be utilized alone or in admixture with a peptide composition derived therefrom. Alternatively, the peptide composition can be added alone to the uncooked food.

The term “a surface” as used herein is a surface of uncooked food which is positioned 90 degrees from an adjacent surface or surfaces of the uncooked food. In addition, the term “a surface” can comprise the connecting surface connecting two adjacent surfaces positioned 90 degrees from each other. Preferably, the entire surface of the uncooked food is coated with the dry acidic protein mixture, dry alkaline protein mixture, aqueous alkaline protein solution or aqueous acidic protein solution. The uncooked food containing the protein and/or the peptide then can be cooked at elevated temperature in oil and/or fat while substantially preventing absorption of oil and/or fat by the food being cooked.

In one aspect of this invention, particulate food such as ground meat or fish, e.g. hamburger, or a food mixture such as a pastry for doughnuts is mixed with the acidic dry protein mixture, alkaline dry protein mixture, aqueous alkaline protein solution or aqueous acidic protein solution comprising myofibrillar proteins and sarcoplasmic proteins and/or the peptide composition derived therefrom at a weight ratio usually comprising about 0.03 to about 18% weight of the protein and/or peptide mixture based on the weight of the uncooked food, preferably between about 0.5 and 10% weight based on the weight of uncooked food and most preferably comprising between about 0.5 to about 7% weight based on the weight of the uncooked food. When the acidic dry protein mixture, alkaline dry protein mixture, aqueous alkaline protein mixture or aqueous acidic protein solution and/or peptide composition derived therefrom is applied to at least one surface of the food, the amount of the protein and/or peptide mixture added is the same weight ratio as set forth above when mixed with uncooked food. When utilizing less than about 0.03% weight protein and/or peptide mixture or aqueous acidic protein and/or peptide solution, prevention of oil and/or fat absorption is not observed. When utilizing greater than about 15% weight protein and/ or peptide, the uncooked food can become undesirably hard.

Suitable oils and/or fats, including hydrogenated or non-hydrogenated oils which can be utilized to effect cooking of uncooked food are those conventionally used in cooking including lard, peanut oil, corn oil, vegetable oil, canola oil, olive oil, palm oil, coconut oil, sesame oil, sunflower oil, butter, mixtures thereof or the like.

The uncooked food which is modified in accordance with this invention comprises meat, poultry and fish, including shell fish, vegetables, such as potato or onion, tempura; nuts, mushrooms, flour based foods such as batter compositions, pastry compositions, chicken or the like. Representative suitable fish include deboned flounder, sole, haddock, cod, sea bass, salmon, tuna, trout or the like. Representative suitable shell fish include shelled shrimp, crabmeat, crayfish, lobster, scallops, oysters, or shrimp in the shell or the like. Representative suitable meats include ham, beef, lamb, pork, venison, veal, buffalo or the like; poultry such as chicken, mechanically deboned poultry meat, turkey, duck, a game bird or goose or the like either in fillet form or in ground form such as hamburg. The meats can include the bone of the animal when the bone does not adversely affect the edibility of the meat such as spare ribs, lamb chops or pork chops. In addition, processed meat products which include animal muscle tissue such as a sausage composition, a hot dog composition, emulsified product or the like can be coated, injected or mixed with the acidic dry protein mixture, alkaline dry protein mixture, aqueous alkaline protein solution or the aqueous acidic protein solution, and/or peptide composition derived therefrom or a combination of these addition methods. Sausage and hot dog compositions include ground meat or fish, herbs such as sage, spices, sugar, pepper, salt and fillers such as dairy products as is well known in the art. Representative vegetables include potato, carrot, cauliflower, onion, corn or the like. Additional foods include mushroom, nuts, batter compositions such as those comprising flour, egg and milk which can include additional food such as cornmeal, cracker meal or dusting meals.

The food containing the acidic dry protein mixture, alkaline dry protein mixture, aqueous alkaline protein solution or aqueous acidic protein solution and/or the peptide composition then can be cooked with oil and/or fat in a conventional manner such as by deep fat frying, pan frying, or the like. It has been found that the uncooked food provided in accordance with this invention contains between about 10% and about 70%, preferably between about 30% and about 70% less oil and/or fat by weight as compared to the same uncooked food free of the protein and/or peptide composition of this invention. The amount of fat or oil needed to cook a given weight of a given type of food also is correspondingly reduced.

In one aspect of this invention, it has been found that the addition of ethanol to the acidic dry protein mixture, alkaline dry protein mixture, aqueous acidic protein solution, aqueous alkaline protein solution and/or peptide solution or to a coating such as a batter containing the protein and/or peptide mixture results in a further reduction of fat and/or oil in food cooked in fat and/or oil as compared to the addition of the protein and/or peptide without ethanol. The concentration of ethanol for which this effect is observed is between about 0.5 and about 5% by weight, preferably between about 1% and about 5% by weight based on the total weight of batter and added protein and/or peptide.

The following examples illustrate the present invention and are not intended to limit the same. Percent (%) reflects the comparative reduction of absorbed fat and/or oil in the compositions of this invention as compared to absorbed fat and/or oil by the untreated batter of the control (fat and/or oil grams of a composition of this invention of control X 100). All products were analyzed at Silliker Laboratory, Allentown, Pa. Analysis method was fat (AOAC 948.15.

### EXAMPLE 1

### Extracted Pollock Proteins to Reduce or Control Fat Up-take in Breaded Commercial Fish Portions

A pollock protein solution was manufactured according to U.S. Pat. No. 6,451,975 and concentrated using ultrafiltration and a 500,000 NWCO membrane filter (Koch Membrane, Wilmington, Mass.). Commercial 2.5 oz raw breaded pollock squares were obtained prior to frying.

Frozen Pollock pieces were ground (Stephan Micro-cut, Columbus, Ohio) and then acidified in phosphoric acid, pH 3.0 to from the pollock protein solution, 3 wt. % solution of dissolved solids. After ultrafiltration, a retentate 3 Brix solution corresponding to an approximately 2 wt/% protein solution was recovered.

One half of the 4.0 oz ( a serving) Pollock portions were dipped into the pollock protein (3% Brix) and shaken to rid of excess protein (total 9.2% wt. pick-up), prior to being placed into a deep-fat fryer to partially fry for approx. 30 seconds at 390° F. The cooked Pollock portions were subjected to a stream of superatmospheric air upon exiting the deep fat fryer onto a mesh conveyer to remove accumulated fat and/or oil from the surfaces of the portions. Controls were from the same lot of portions but were deep fat fried without any added protein. The controls were not exposed to pressurized air. Product was frozen and analyzed by combining 3-4 replicate portions of each sample as a composite sample. Samples of Pollock portions were taken from a production line after being cooked over time periods set forth in Table 1. Fat content in all samples were tested by hydrolysis by AOAC 948.15 method. The results are set forth in Table 1.

TABLE 1

| Sample | Day | Time | | Fat content, Wt. % |
|---|---|---|---|---|
| Control | 1 | 9:30 | A.M. | 4.52 |
| Control | 1 | 1:00 | P.M. | 4.40 |
| Control | 1 | 4:00 | P.M. | 4.42 |
| Control | 2 | 9:00 | A.M. | 4.81 |
| Control | 2 | 10:30 | A.M. | 4.59 |
| Control | 2 | 5:00 | P.M. | 4.81 |
| Sample of This Invention | 3 | 8:00 | A.M. | 2.9 |
| Sample of This Invention | 3 | 9:00 | A.M. | 3.3 |
| Sample of This Invention | 3 | 11:00 | A.M. | 3.6 |
| Sample of This Invention | 3 | 1:00 | P.M. | 3.1 |
| Sample of This Invention | 3 | 3:00 | P.M. | 2.8 |
| Average Fat Content for | | | | 3.14 |
| Samples of This Invention | | | | |

Under U.S. Food and Drug Administration rules a food can be labeled “low fat” when it contains less than 3 g wt. % fat per serving. As set forth in Table 1, 4 of 5 samples of this invention met this criteria and the average of these samples met the criteria.

1. The process for reducing absorption of fat and/or oil in uncooked food during cooking of the food with a fat and/or oil which comprises:
(a) adding to said uncooked food a protein composition and/or a peptide composition selected from the group consisting of an acidic dry protein mixture of myofibrillar proteins and sarcoplasmic proteins derived from animal muscle tissue, an aqueous acidic protein solution of myofibrillar proteins and sarcoplasmic proteins derived from animal muscle tissue and a peptide composition derived from myofibrillar proteins and sarcoplasmic proteins that are derived from animal muscle tissue and mixtures thereof by an adding method selected from the group consisting of applying said protein and/or peptide composition to at least one surface of said uncooked food, mixing said protein and/or peptide composition with said uncooked food, injecting said protein and/or peptide composition mixture into said uncooked food and a combination of said adding methods
(b) cooking said uncooked food and protein and/or a peptide composition from step (a) in an oil and/or fat
and (c) removing accumulated fat and/or oil from surfaces of food from step (b).

2. The process for reducing absorption of fat and/or oil in uncooked food during cooking of the food with a fat and/or oil which comprises:
(a) adding to said uncooked food a protein composition and/or a peptide composition selected from the group consisting of an alkaline dry protein mixture of myofibrillar proteins and sarcoplasmic proteins derived from animal muscle tissue, an aqueous alkaline protein solution of myofibrillar proteins and sarcoplasmic proteins derived from animal muscle tissue and a peptide composition derived from myofibrillar proteins and sarcoplasmic proteins that are derived from animal muscle tissue and mixtures thereof by an adding method selected from the group consisting of applying said protein and/or peptide composition to at least one surface of said uncooked food, mixing said protein and/or peptide composition with said uncooked food, injecting said protein mixture and/or peptide composition into said uncooked food and a combination of said adding methods
(b) cooking said uncooked food and protein and/or a peptide composition from step (a) in an oil and/or fat
and (c) removing accumulated fat and/or oil from surfaces of food from step (b).

3. The process of claim 1 wherein the protein and/or a peptide composition of myofibrillar proteins and sarcoplasmic proteins is applied to at least one surface of said uncooked food.

4. The process of claim 1 wherein the protein composition and/or peptide composition of myofibrillar proteins and sarcoplasmic proteins is applied to all surfaces of said uncooked food.

5. The process of claim 1 wherein the protein composition and/or peptide composition of myofibrillar proteins and sarcoplasmic proteins is mixed with said uncooked food.

6. The process of claim 1 wherein the protein composition and/or peptide composition is injected into said uncooked food.

7. The process of claim 1 wherein the protein composition and/or peptide composition is injected into said uncooked food and is applied to all surfaces of said uncooked food.

8. The process of claim 1 wherein said protein composition and/or said peptide composition is mixed with said uncooked food and is applied to all surfaces of said uncooked food.

9. The process of claim 1 wherein said protein composition and/or peptide composition is an acidic dry protein mixture and/or a peptide composition of myofibrillar proteins and sarcoplasmic proteins derived from animal muscle tissue.

10. The process of claim 1 wherein said protein and/or a peptide composition is an aqueous acidic protein solution and/or a peptide composition solution of myofibrillar proteins and sarcoplasmic proteins derived from animal muscle tissue.

11. The process of any one of claims 1, 2, 3, 4, 5, 6, 7 or 8 wherein said uncooked food is fish.

12. The process of any one of claims 1, 2, 3, 4, 5, 6, 7 or 8 wherein said uncooked food is shell fish.

13. The process of claim 12 wherein said shellfish is shrimp.

14. The process of claims 1, 2, 3, 4, 5, 6, 7 or 8 wherein said uncooked food is poultry.

15. The process of claim 14 wherein said poultry is selected from the group consisting of turkey, duck, goose, game bird and chicken.

16. The process of any one of claims 1, 2, 3, 4, 5, 6, 7 or 8 wherein said uncooked food is meat.

17. The process of claim 16 wherein said meat is selected from the group consisting of ham, beef, lamb, pork, veal, buffalo and venison.

18. The process of any one of claims 1 or 2 wherein said uncooked food is a vegetable.

19. The process of claim 18 wherein said vegetable is potato.

20. The process of claim 18 wherein said vegetable is onion.

21. The process of any one of claims 1 or 2 wherein said food is a flour based food.

22. The process of any one of claims 1, 2, 3, 4, 5, 6, 7 or 8 wherein said protein composition and/or a peptide composition is derived from fish muscle tissue.

23. The process of any one of claims 1, 2, 3, 4, 5, 6, 7 or 8 wherein said protein and/or peptide composition is derived from poultry muscle tissue.

24. The process of any one of claims 1, 2, 3, 4, 5, 6, 7 or 8 wherein said protein composition and/or peptide composition is derived from meat muscle tissue.

25. The process of claim 24 wherein said protein composition and/or peptide composition is meat muscle tissue selected from the group consisting of beef, lamb, pork and mixtures thereof.

26. The process of any one of claims 1, 2, 3, 4, 5, 6, 7 or 8 wherein said protein composition and/or a peptide composition is substantially free of animal membrane lipids.

27. The process of any one of claims 1, 5, 7 or 8 wherein said food is in a sausage composition.

28. The process of any one of claims 1, 5, 7 or 8 wherein said food is in a hot dog composition.

29. The process of any one of claims 1, 3, 4, 5, 6, 7, 8, 9 or 10 wherein the pH of said acidic dry protein mixture, said aqueous acidic protein solution and said peptide composition is between about 2.5 and about 3.5.

30. The process of claim 1 wherein the uncooked food is frozen.

31. The process of claim 2 wherein the uncooked food is frozen.

32. The process of any one of claims 1 or 2 wherein the fat and/or oil is removed from the surfaces of the food with superatmospheric gas.

33. The process of claim 11 wherein the pH of said acidic dry protein mixture, said aqueous acidic protein solution and said peptide composition is between about 2.5 and about 3.5.

34. The process of claim 12 wherein the pH of said acidic dry protein mixture, said aqueous acidic protein solution and said peptide composition is between about 2.5 and about 3.5.

35. The process of claim 13 wherein the pH of said acidic dry protein mixture, said aqueous acidic protein solution and said peptide composition is between about 2.5 and about 3.5.

36. The process of claim 14 wherein the pH of said acidic dry protein mixture, said aqueous acidic protein solution and said peptide composition is between about 2.5 and about 3.5.

37. The process of claim 15 wherein the pH of said acidic dry protein mixture, said aqueous acidic protein solution and said peptide composition is between about 2.5 and about 3.5.

38. The process of claim 16 wherein the pH of said acidic dry protein mixture, said aqueous acidic protein solution and said peptide composition is between about 2.5 and about 3.5.

39. The process of claim 17 wherein the pH of said acidic dry protein mixture, said aqueous acidic protein solution and said peptide composition is between about 2.5 and about 3.5.

40. The process of claim 18 wherein the pH of said acidic dry protein mixture, said aqueous acidic protein solution and said peptide composition is between about 2.5 and about 3.5.

41. The process of claim 19 wherein the pH of said acidic dry protein mixture, said aqueous acidic protein solution and said peptide composition is between about 2.5 and about 3.5.

42. The process of claim 20 wherein the pH of said acidic dry protein mixture, said aqueous acidic protein solution and said peptide composition is between about 2.5 and about 3.5.

43. The process of claim 21 wherein the pH of said acidic dry protein mixture, said aqueous acidic protein solution and said peptide composition is between about 2.5 and about 3.5.
